(19) United States
(12) Patent Application Publication
(10) Pub. No.: US 2007/0046479 A1
(43) Pub. Date: Mar. 1, 2007

(54) Concrete maturity monitoring system using passive wireless surface acoustic wave temperature sensors

(75) Inventor: Jacqueline H. Hines, Annapolis, MD (US)

Correspondence Address: SCHIFF HARDIN, LLP;PATENT DEPARTMENT, 6600 SEARS TOWER, CHICAGO, IL, 60606-6473, US

(73) Assignee: Applied Sensor Research & Development Corporation, Annapolis, MD (US)

(21) Appl. No.: 11/212,851

(22) Filed: Aug. 26, 2005

(51) Int. Cl. G08B 17/00

(52) U.S. Cl. 340/584

(57) ABSTRACT

A method and apparatus for wireless measurement of the temperature in curing concrete is characterized by the use of a plurality of surface acoustic wave temperature sensors embedded in the concrete. An interrogation signal from an external transceiver system is modified by the sensors in accordance with the temperature of the concrete adjacent to the sensors. The return signals from the sensors are processed in a correlation device to identify each signal as originating from a specific sensor. A microprocessor calculates the maturity of the concrete based on the data received from the sensors as well as data input corresponding to the type of concrete. The maturity data is used to analyze the strength and integrity of the concrete structure being built.

### BACKGROUND OF THE INVENTION

The present invention generally relates to methods and devices for in-situ monitoring of the strength of curing concrete.

Determination of the strength of curing concrete is a crucial requirement for the quality assurance of many industrial construction projects. A non-destructive way to determine the in-situ concrete strength can provide significant advantages to construction schedules, while assuring safety through adequate quality assurance of the construction. Completion of projects on or ahead of schedule can result in significant fiscal benefits to contractors for major infrastructure projects.

Strength development in concrete is primarily controlled by two factors, time and temperature of hydration. In-situ strength measurements are the most relevant, as they provide information about the actual structure under construction, rather than relying on separate concrete test structures. Using typical technology, test specimens (cylinders or beams) are cast from the same batch of concrete that is used in the construction project. These test specimens then undergo a range of strength tests to establish their in-place strength as they cure. However, due to the potential difference in conditions between the placement of the test specimens and the structure, the thermal history of the test specimen can vary substantially from that of the structure under construction. This can lead to errors in strength estimations for the structure.

An alternative non-destructive method for determining the strength of curing concrete is called the Maturity Method. This method calculates the degree of cementious hydration that has occurred within the concrete mass (the “Maturity Index”), based on the actual thermal history of the concrete, and uses this value to predict strength based on comparisons to established strength-maturity relationships for the specific mix used.

There are two principal methods for calculating the Maturity Index, the Nurse-Saul method and the Arrhenius method. The Maturity Method has been adopted as a standard approach to determining the strength of curing concrete in ASTM C 1074. Verification of the strength-maturity relationship is required per ASTM C 1074 prior to performing critical operations, such as removal of formwork or post-tensioning.

The Nurse-Saul Material Function provides the maturity index as a function of time:
M(t)=Σ(Tₐ−T₀)Δt (1)
where:
M(t)=maturity index (as time-temperature factor) in ° C.-days or ° C.-hrs
Tₐ=average temperature during each time interval
T₀=temperature below which cementious hydration is assumed to cease (datum temperature)
Δt=time intervals (hours or days)
   and Σ represents a summation over all time intervals of interest (time since the pour) of the time-temperature product. The datum temperature is mix-specific, and is affected by numerous mix parameters, including water-to-cement ratio and admixtures. This parameter should be determined per American Standard Testing Method (ASTM) C 1074 in order to obtain accurate strength estimations using equation (1).

An alternative method for calculating the maturity index is the Arrhenius method. This method takes into account the activation energy of the concrete, and calculates the maturity as an equivalent age.

$${M}_{A} ( t ) = {\sum }_{t = 0}^{t} [ {ⅇ}^{- \frac{Ea}{R} \cdot ( \frac{1}{T + 273} - \frac{1}{{T}_{r} + 273} )} \cdot Δ t ] \qquad ( 2 )$$

where:
M_{A}(t)=maturity index (as equivalent age) in days or hrs
T=average temperature of concrete during each time interval (° C.)
Tᵣ=reference temperature (° C.)
Δt=time intervals (hours or days)
Eₐ=apparent activation energy (J/mole)
R=universal gas constant (8.3144 J/mole/K)

Using either maturity index and pre-determined strength-maturity relationships established for the specific concrete mix, the mechanical strength of the concrete can be calculated.

### BRIEF DESCRIPTION OF THE PRIOR ART

Current techniques for measuring the in-situ temperature of concrete and implementing the maturity method for strength calculations involve embedding either wired temperature sensors or entire sensor/data logging systems in the wet concrete. In the simplest case of wired sensors, such as thermocouples of various kinds, the temperature data is transmitted in real time via wired connections from the temperature sensor to a data-logger outside the concrete surface. This data can then be manipulated and maturity and concrete strength calculated. Other current wired-sensor implementations utilize both a sensor and a data-logging system (battery, memory, and associated electronics) to take and store temperature data on the embedded sensor module, and then download the data via a wired connection to a computer or external data-logger as needed. An example of a known wired system used to evaluate concrete is disclosed in the Radjy U.S. Pat. No. 4,943,930.

While the prior art devices operate satisfactorily, the wired system implementations have the substantial drawback that the wires and connections are relatively fragile and easily damaged in the construction environment. Such damage may require the removal of sections of concrete to locate and re-connect to buried sensors if the wires are severed during the concrete pour or thereafter.

Currently available wireless maturity monitors include a temperature sensor, a microprocessor, a memory device, associated electronics, an antenna, and a battery manufactured as a unit within a durable case. This unit can be attached to rebar or other structures prior to the concrete pour, and can subsequently monitor the temperature of the concrete during cure or the maturity thereof. These systems log temperature data, and store data regarding the concrete mix so that maturity method calculations can be performed. They utilize radio frequency (RF) communications to transmit this data to the surface, either to a specially equipped personal computer (PC) or to a hand-held data collection and evaluation device. These systems are generally capable of providing raw temperature data as well as processed maturity information. They are capable of operating relatively near the surface of the concrete (through up to about 8 inches of concrete) without external antennae, and their range can be extended by utilizing external antennas connected to the embedded system by cables.

This approach, placing the antenna end of the cable near or at the surface of the pour, can extend the operating range of such systems to several feet of concrete. The range of the interrogation systems used to download data from these embedded systems varies. The operational system lifetime is generally more than sufficient to cover the normal curing time for concrete structures, but the battery will eventually run down and no further information can be gained from these systems. The cost of such embedded sensor systems (which are considered disposable, as they cannot be recovered after use) is relatively high, due to the expensive components used. These systems are also fairly large (often bars that are several inches long by an inch or so in each other direction).

### SUMMARY OF THE INVENTION

The present invention was developed in order to overcome these and other drawbacks of the prior art devices. It provides a system for wirelessly measuring the temperature of curing concrete and determining the maturity (or strength of the concrete), utilizing multiple, uniquely identifiable wireless temperature sensors that are completely passive. These sensors, which are based on surface acoustic wave (SAW) technology, use the energy contained in an interrogation signal, such as an RF signal to activate the sensor, measure the desired parameter (in this case temperature), and radiate a device response back to the receiver. The simplicity of these devices allows for the embedded portion of the sensor system to consist solely of SAW temperature sensors with attached antennae. These sensors can be substantially smaller and less expensive than current embedded systems, while providing similar temperature data. Also, since they are not dependent on a battery for operation, these sensors have essentially unlimited lifetimes.

The low cost and small size of these sensors, combined with their inherent ruggedness, allows structural engineers to monitor the thermal history of the curing concrete in numerous locations throughout a structure. It is possible for hundreds or even thousands of these sensors to be distributed throughout a volume to be monitored, and monitoring may occur automatically using the proposed interrogation system. This will provide a structural engineer with the data necessary for the engineer to visualize what is happening within the structure as it cures. The interrogation system can then report when the desired strength has been achieved in particular portions of the structure, or it can alarm or contact a job engineer/supervisor if the temperature is close to a level of concern.

A number of SAW temperature sensor devices are well known. SAW reflective delay lines have been used as tag or identification devices for years, and have also been used as sensors. SAW differential delay line temperature sensors have recently been demonstrated, including those using a novel coding known as Orthogonal Frequency Coding (OFC). OFC, which is a spread spectrum approach, has the advantage of increased processing gain relative to ordinary approaches. This allows for improved accuracy and increased sensor detection range. SAW resonators also exhibit a variation in resonant frequency based on the device temperature and the temperature coefficient of frequency (TCF) of the piezoelectric substrate. Thus, resonant SAW devices can also be used as temperature sensors, given an appropriate choice of substrate and wave propagation direction for the device.

The proposed interrogation system is designed to operate with the selected SAW temperature sensor or sensors. Interrogation systems for SAW sensors have been demonstrated that include pulsed radar architectures, Fourier transform measurement systems, and delay line and resonator-based oscillator systems. In general, all of these systems have the common elements of: RF signal generation, amplification, and transmission through an antenna to the sensor; RF signal reception through an antenna of the sensor response; amplification, signal processing, down-mixing, and digitizing of the sensor signal response; and digital data analysis to determine sensor response. Since SAW devices are linear, coherent systems can be used. Quadrature demodulation can be implemented in the receiver unit before sampling and digitizing. Reading the SAW sensor takes only a few microseconds, which allows for time integration of the sensor response over a short time period to include many RF responses. This enhances the signal-to-noise ratio (SNR), and each 12 dB increase in SNR doubles the device read-out distance.

The interrogation system includes time integration of the sensor response, and adds to the selected architecture a computer or microprocessor and associated software to translate the measured sensor response into a concrete maturity index and strength measurement. Audible or visual alarms, automatic communication to one or more external computers, cell phones, web sites, or the like are provided to communicate the results.

### BRIEF DESCRIPTION OF THE FIGURES

Other objects and advantages of the invention will become apparent from a study of the following specification when viewed in the light of the accompanying drawing, in which:

FIG. 1 is a block diagram of the concrete maturity monitoring system according to the invention;

FIG. 2 is a perspective view of a differential delay line sensor with a SAW device implementation of orthogonal frequency coding;

FIG. 3 is a graph showing the impulse response of the OFC differential delay line device shown in FIG. 2;

FIG. 4 is a block diagram for a transceiver system to be used with OFC SAW temperature sensors;

FIGS. 5a and 5b are graphs plotting theoretical and experimental compressed pulses resulting from correlation of the OFC sensor response with the ideal OFC code, respectively; and

FIG. 6 is a block diagram of an interrogation system using SAW reflective delay line sensors for identification.

### DETAILED DESCRIPTION

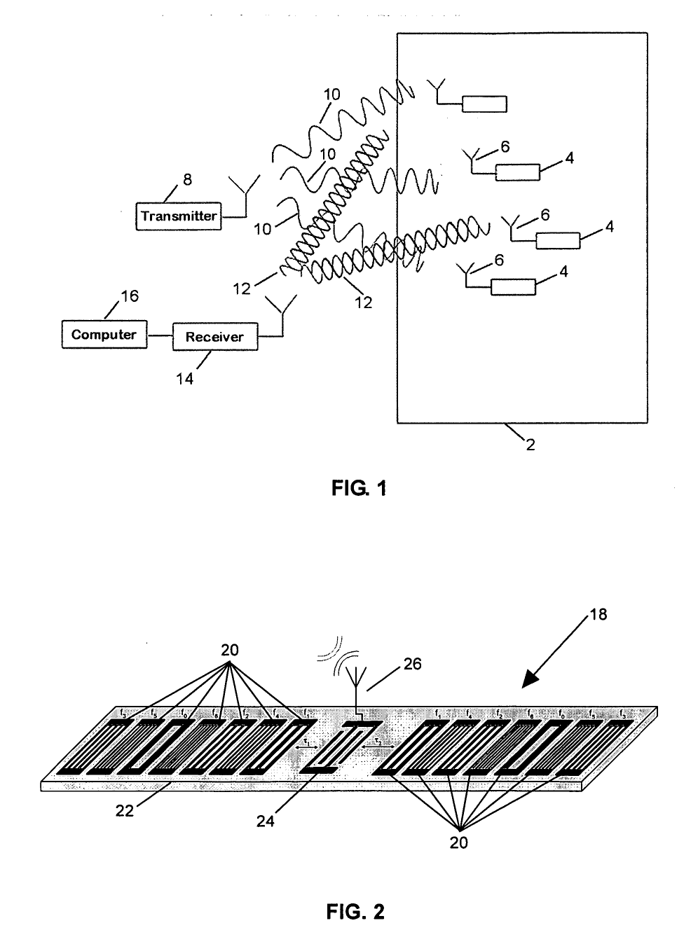

The preferred embodiment of the present invention will be described with reference to FIG. 1. As shown therein, a concrete mass 2 is poured in a form or the like (not shown) to form a structure such as a pillar, building wall, bridge section or suspended slab. A plurality of passive wireless SAW temperature sensors 4 with attached antennae 6 are embedded in the wet concrete as the structure to be monitored is poured. An external transmitter 8 generates RF signals to interrogate the sensors. These signals have specific characteristics, designed to efficiently excite the sensors used. For example, FIG. 1 shows chirped interrogation signals 10 being sent out by the transmitter. Such signals would be used in one of the preferred embodiments, in which the SAW sensors are OFC sensors. The sensors receive the interrogation signal and generate response signals 12. A receiver 14 receives the response signals from the sensors, and a microprocessor or computer 16 processes the signals, evaluates the identification information of the sensor and calculates a measurand. Integration of the individual sensor responses over time occurs within the computer 16 as well.

While the receiver and computer are shown in the drawing as separate elements, the computer or microprocessor can be embedded within the receiver itself. Similarly, as will be appreciated by those in the art, the transmitter and receiver may be combined in a single unit as a transceiver which incorporates the necessary computational equipment as well. Depending on the range over which the sensors are to be monitored, the use of RF signal repeaters may be provided. In addition, signal processing can be done at a remote location with the data from the sensors being transmitted via wired or wireless communication devices. For large concrete structures, a series of transceivers may be used, each cooperating with a specific group of sensors to monitor specific areas of the structure. Separate computations may be performed for each transceiver, or the data therefrom can be delivered to a central processing unit. Thus, a wide variety of applications are possible with the invention.

As set forth above, the SAW sensors 4 are preferably orthogonal frequency coded (OFC) temperature sensors which are individually identifiable. In an alternate embodiment, the multi-sensor system utilizes individually identifiable traditionally coded reflective delay line (tag) temperature sensors. In a further embodiment, the system uses the frequency diversity of multiple SAW resonator temperature sensors for individual sensor identification. The specific architecture of the transceiver will be appropriate for the type of SAW sensor being used. In general, for all transceivers, integration of multiple responses from each sensor results in increased signal to noise levels and therefore increased system range.

One preferred embodiment of the current concrete maturity monitoring system is a multi-sensor system utilizing individually identifiable Orthogonal Frequency Coded (OFC) SAW temperature sensors. The theory behind OFC is explained in Malocha, D. C. et al, “Orthogonal Frequency Coding for SAW Device Applications,” Proceedings of the 2004 IEEE International Ultrasonics, Ferroelectrics, and Frequency Control Symposium, Montreal Canada, August 2004. Basically, OFC is the use of orthogonal frequencies to encode a signal, which spreads the signal bandwidth and is analogous to a fixed M-ary frequency shift signal.

This type of coding is easily implemented on a SAW device, by fabricating reflective arrays consisting of the desired number of reflectors, each with specified center frequency and bandwidth characteristics that ensure orthogonality to the other reflectors being used. FIG. 2 shows a differential delay line temperature sensor 18 utilizing this technology which is described in Puccio, D. et al, “SAW Sensors Using Orthogonal Frequency Coding,” Proceedings of the 2004 IEEE International Ultrasonics, Ferroelectrics, and Frequency Control Symposium, Montreal Canada, August 2004. The sensor 18 includes two sets of arrays of reflectors 20 arranged on a piezoelectric substrate 22 in a mirror image arrangement on opposite sides of an input/output transducer 24 with differing initial delays τ₁ and τ₂. An antenna 26 is connected with the transducer. The differential delay line sensor 18 of FIG. 2 can be a temperature sensor, or it can be modified to sense other parameters by modifying specific portions of the device to provide specific responses to chemical vapors or other measurands.

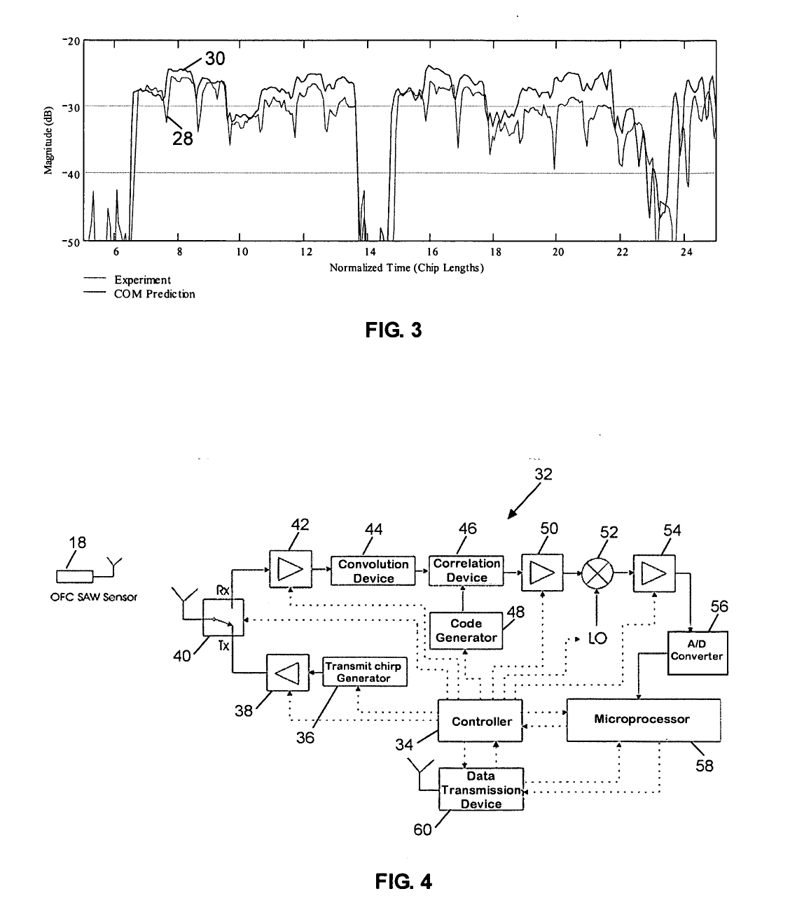

The impulse response of the OFC differential delay line sensor 18 of FIG. 2 is shown in FIG. 3. Note the two sets of responses from the two sets of reflective arrays on either side of the input/output transducer. Pseudo noise (PN) sequences can also be added for additional coding. The OFC technique provides a wide bandwidth spread spectrum signal with all the inherent advantages obtained from the time-bandwidth product increase over the data bandwidth. Specifically, orthogonal frequency coding of these devices results in reduced time ambiguity of the compressed pulses and increased processing gain compared to conventional PN coding using a single carrier frequency. These factors result in increased measurement accuracy and increased sensor system range, respectively. The lower trace 28 in FIG. 3 is the experimental device response, while the upper trace 30 is the ideal calculated device impulse response. The two sets of coded reflections are separated in time, due to the differential delay of the device. That is, τ₂ is greater than τ₁ (FIG. 2) by enough to cause the responses of the two reflector arrays to not overlap.

FIG. 4 shows a transceiver system 32 to be used with OFC SAW temperature sensors 18, only one of which is shown. Due to the nature of these sensors, this system has some unique attributes. In order to efficiently transmit power into the sensors, the interrogation signal generated by the transmitter is a spread spectrum signal matched to the spectrum of the sensor devices. A controller 34 activates a transmit chirp generator 36 which is amplified by an amplifier 38 and then transmitted by a switch and antenna assembly 40. The transmitted chirp signal is convolved with the OFC sensor response (in the sensor 18), and the signal sent back to the transceiver is a noise-like spread-spectrum signal.

The received signal is amplified by an amplifier 42 and processed in a convolution device 44 with a chirp signal that is the opposite of the transmit chirp. The processed signal is sent to a correlation device 46 where the signal is correlated with known sensor codes from a code generator 48 to determine which sensor is responding (or to separate the overlapping responses of multiple sensors) and to obtain compressed pulses for detection. The correlated signal is amplified by and amplifier 50 and mixed by a mixer 52 down to lower frequency (IF or baseband). The signal is amplified again (if needed) by an amplifier 54 and then digitized in an analog to digital (A/D) converter 56. Quadrature demodulation can be performed prior to the A/D conversion to provide both in-phase and quadrature digitized data channels. The digital data signal is then processed in a microprocessor 58 to detect the compressed pulses, to integrate each sensor response over multiple interrogations, and to calculate the temperature at each sensor. Based on these calculations, and on information about the specific concrete mix being used, the maturity index of the concrete is calculated by the microprocessor. This information can then be stored in a memory in the microprocessor and communicated to the end user by any suitable device such as a wireless data transmission device 60. Alternatively, temperature data can be transmitted to an external computer by the wireless data transmission device 60, where maturity index calculations may be performed.

The chirp signal transmitted by the transceiver system 32 to the OFC sensor 18 is a spread spectrum signal matched to the spectrum of the sensor devices. Generation of this chirp can be accomplished by direct digital synthesis (DDS), or by using a fixed surface acoustic wave chirp device, or by using a signal generator. A SAW device implementation is simple, and therefore is preferred for this application. However, since this chirp signal serves only to excite the sensor device, its precise characteristics are not critical as long as the bandwidth and time extent are appropriate. The chirp can be linear, stepped, or non-linear. Each of these will result in a slightly different interaction with the sensors. In the receiver portion of the transceiver 44, however, the signal convolves with a chirp device that is the opposite of the transmit chirp. This removes the effect of the transmit chirp on the signal, and returns the sensor response. Thus the specific chirp chosen for the transmit is not critical, as long as the appropriate opposite chirp is used for the receive.

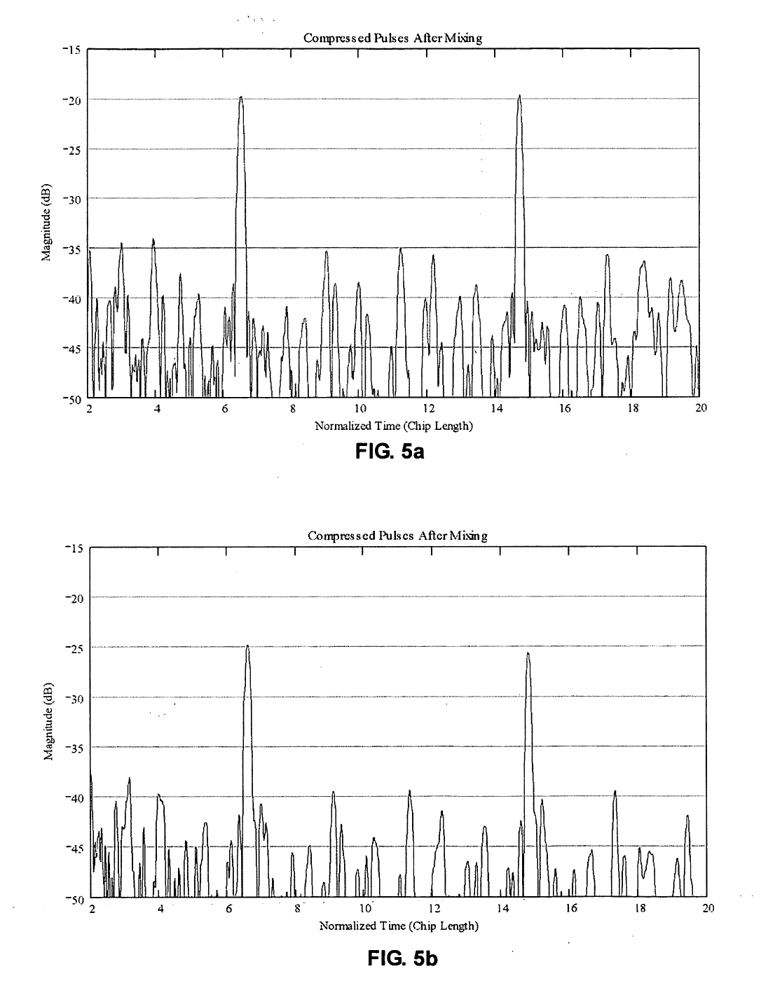

FIGS. 5a and 5b are graphical representations of the compressed pulses resulting from correlation of the OFC sensor response with the ideal OFC code at the output of the correlation device 46 of FIG. 4. The curve in FIG. 5a represents the theoretical response and the curve in FIG. 5b represents the experimental response.

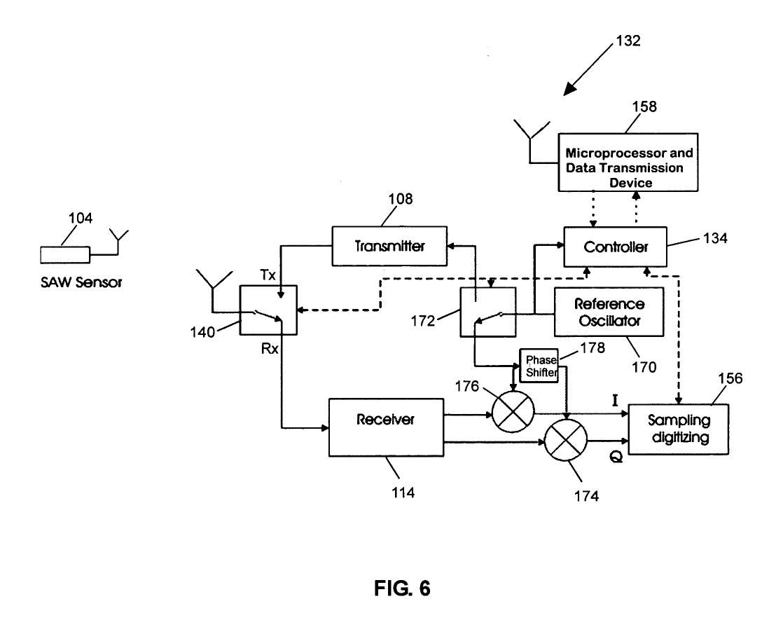

An alternate embodiment of the current concrete maturity monitoring system is shown in FIG. 6. This embodiment comprises a multisensor system utilizing individually identifiable traditionally coded reflective delay line (tag) temperature sensors 104. Such sensors could be interrogated using standard transceiver approaches that are similar to those used in radar. Generally, these approaches are coherent, and quadrature demodulation can be used as shown in FIG. 6.

The transceiver system 132 includes a switch and antenna assembly 140 under operation of a controller 134 and having a transmitter 108 and a receiver 114 connected therewith. A reference oscillator 170 generates a frequency signal to a switch 172 which delivers the signal to the transmitter for transmission to the sensors. The transmitted signal convolves with the SAW sensor response, and a signal is sent back to the receiver. The received signal under goes quadrature demodulation through mixers 174 and 176, in conjunction with phase shifter 178, resulting in inphase signal I and quadrature signal Q. The signals are sampled and digitized by a converter 156 and delivered to the controller for further processing by a microprocessor and data transmission device 158 as in the embodiment of FIG. 4.

An alternate embodiment of the concrete maturity monitoring system utilizes frequency diversity of multiple SAW resonator temperature sensor for individual sensor identification. Yet another embodiment utilizes the difference frequency between SAW resonators as the measurand characteristic of the device temperature. In either embodiment, the interrogation system would be a frequency measurement system. Standard approaches to frequency measurement include the use of oscillators and of vector analyzer approaches. A different measurement technique for use with SAW resonator sensors comprises transmitting a pulse to the sensor, receiving and digitizing the sensor response recorded in time, and Fourier transforming the time domain response to obtain the sensor resonance frequency.

It will be appreciated by those of ordinary skill in the art that temperature sensor devices based on bulk acoustic wave technology, including thin-film bulk acoustic wave technology, may also be utilized with interrogation systems such as those described herein.

In all embodiments, the calculation of the maturity index of the concrete can be done using the Nurse-Saul Material Function or the Arrhenius method, at the selection of the user. In addition, for all of these embodiments, the user is able to enter information about the concrete being used (including activation energy, concrete type, and strength-maturity information), time of pour, desired interval between sensor readings, desired alarm conditions, and desired communication devices for reporting results. The user can also select which data is available for download to other applications for further analysis and presentation purposes. These entries would be made through a software interface.

While the preferred forms and embodiments of the invention have been illustrated and described, it will be apparent to those of ordinary skill in the art that various changes and modifications may be made without deviating from the inventive concepts set forth above.

What is claimed is:

1. A system for the wireless measurement of the temperature within curing concrete, comprising:
(a) at least one passive acoustic wave temperature sensor embedded in wet concrete;
(b) a transceiver external to the concrete for transmitting an interrogating signal to said sensor and for receiving at least one sensor response signal;
(c) signal processor means for processing said sensor response signal to determine the sensor temperature as it changes during cure of the concrete; and
(d) calculating means for calculating maturity of the concrete in accordance with sensor temperature over time.

2. A system as defined in claim 1, wherein said sensor is a surface acoustic wave temperature sensor.

3. A system as defined in claim 2, wherein said sensor is an orthogonal frequency coded surface acoustic wave temperature sensor.

4. A system as defined in claim 3, wherein the said sensor is an orthogonal frequency coded surface acoustic wave differential delay line temperature sensor.

5. A system as defined in claim 2, wherein and further comprising a chirp generator connected with said transceiver for generating a chirp interrogation signal.

6. A system as defined in claim 5, wherein said signal processor means processes said sensor response signal with a chirp signal opposite to said chirp interrogation signal.

7. A system as defined in claim 6, wherein said signal processor means comprises a correlation device and a known code generator which process said sensor response signal in order to identify which sensor has produced said sensor response signal.

8. A system as defined in claim 1, and further comprising a data transmission device for communicating the concrete maturity output from said calculating means.

9. A system as defined in claim 2, wherein said signal processor means performs time integration of the received sensor response to improve signal to noise ratios, thereby to improve the range of the system.

10. A system as defined in claim 2, wherein said signal processor means includes a quadrature demodulator for producing in-phase and quadrature channel measurements for each sensor response signal.

11. A system as defined in claim 3, wherein said orthogonal frequency coded surface acoustic wave temperature sensor is also PN coded.

12. A system as defined in claim 2, wherein said at least one passive acoustic wave temperature sensor is a surface acoustic wave resonator.

13. A system as defined in claim 1, wherein said at least one passive acoustic wave temperature sensor comprises a set of uniquely identifiable surface acoustic wave resonators operating at distinct, identifiable frequencies.

14. A system as defined in claim 1, wherein said at least one passive acoustic wave temperature sensor comprises a conventionally coded reflective delay line temperature sensor.

15. A method for the wireless measurement of the temperature within curing concrete, comprising the steps of:
(a) embedding at least one passive acoustic wave temperature sensor in wet concrete;
(b) transmitting an interrogating signal from an external transceiver to said sensor and receiving at least one sensor response signal;
(c) processing said sensor response signal to determine the sensor temperature as it changes during cure of the concrete; and
(d) calculating maturity of the concrete in accordance with sensor temperature over time and with known properties of the concrete.

16. A method as defined in claim 15, wherein said at least one passive acoustic wave temperature sensor is a surface acoustic wave sensor.

17. A method as defined in claim 15, wherein said at least one passive acoustic wave temperature sensor is an orthogonal frequency coded surface acoustic wave sensor.
